(19) United States
(12) Patent Application Publication
(10) Pub. No.: US 2020/0231193 A1
(43) Pub. Date: Jul. 23, 2020

(54) SYSTEMS AND METHODS FOR INSPECTING A RAILROAD TRACK

(71) Applicant: ENSCO, INC., Springfield, VA (US)

(72) Inventors: Xin Chen, Rockville, MD (US); Zhipeng Liu, Fairfax, VA (US)

(21) Appl. No.: 16/632,069

(22) PCT Filed: Jul. 27, 2018
(86) PCT No.: PCT/US2018/044149

§ 371 Date: Jan. 17, 2020

Related U.S. Application Data
(60) Provisional application No. 62/538,524, filed on Jul. 28, 2017.

(51) Int. Cl. B61L 23/04; B61K 9/10; B61L 25/02; B61L 27/00; G01N 21/88; G06T 7/00; H04N 5/232

(52) U.S. Cl. CPC B61L 23/042; B61K 9/10; B61L 25/025; B61L 27/0005; B61L 2205/04; B61L 27/0088; G01N 21/8851; G06T 7/0008; H04N 5/232; B61L 27/0077

(57) ABSTRACT

A method for inspecting a railroad track include detecting, using one or more sensors of an inspection system, movement of a transport device along the railroad track, responsive to the detecting, automatically actuating one or more cameras of the inspection system, receiving, from at least one of the one or more cameras, first image data reproducible as a first image of a first portion of the railroad track, analyzing the first image data to identify the presence or absence of one or more features of interest on the first portion of the railroad track; determining a first location of the transport device, and associating the first location of the transport device with the first image data.

### CROSS-REFERENCE TO RELATED APPLICATIONS

This application claims the benefit of and priority to U.S. Provisional Patent Application No. 62/538,524, filed on Jul. 28, 2017, which is hereby incorporated by reference herein in its entirety.

### TECHNICAL FIELD

The present disclosure relates generally to railroad track inspection systems, and more particularly, to systems and methods for inspecting railroad tracks using one or more cameras that are automatically actuated responsive to movement of a transport device.

### BACKGROUND

Railroad tracks (e.g., subway tracks, elevated train tracks, high speed rail tracks, monorail tracks, tram tracks, etc.) often have defects (e.g., cracks, pitting, misalignment, missing track elements, etc.) that develop over continued use. These defects may negatively impact the quality of the ride along the railroad tracks and/or pose a safety hazard to trains, including derailment. Often, inspecting railroad tracks requires a user to manually operate various devices located on a transport device (e.g., railcar, railroad vehicle, etc.) to collect data to identify the presence or absence of railroad track features of interest, some of which may be considered as defects requiring repair or maintenance. In other words, a user must be physically present on the transport device in order to manually actuate cameras and/or lights of the inspection system. The present disclosure is directed to solving these and other problems.

### SUMMARY

According to some implementations of the present disclosure, a method for inspecting a railroad track includes detecting, using one or more sensors of an inspection system, movement of a transport device along the railroad track; responsive to the detecting, automatically actuating one or more cameras of the inspection system; receiving, from at least one of the one or more cameras, first image data reproducible as a first image of a first portion of the railroad track; analyzing the first image data to identify the presence or absence of one or more features of interest on the first portion of the railroad track; determining a first location of the transport device; and associating the first location of the transport device with the first image data.

According to some implementations of the present disclosure, a system for inspecting a railroad track includes one or more sensors coupled to a wheel of a transport device configured to travel along the railroad track, the one or more sensors being configured to detect movement of the transport device along the railroad track, one or more cameras coupled to the transport device and being configured to generate first image data reproducible as a first image of a first portion of the railroad track, a wireless communication module, one or more memory devices coupled to the transport device and being configured to receive and store the first image data therein, and one or more processors coupled to the transport device and being configured to: automatically actuate the one or more cameras responsive to movement of the transport device along the railroad track and associate a first location of the transport device with the first image data.

According to some implementations of the present disclosure, a method for inspecting a railroad track includes detecting, using one or more sensors of an inspection system, movement of a transport device along the railroad track; responsive to the detecting, automatically actuating one or more cameras of the inspection system; receiving, from at least one of the one or more cameras, first image data reproducible as a first image of a first portion of the railroad track; analyzing the first image data to identify the presence or absence of one or more features of interest on the first portion of the railroad track; determining a first location of the transport device; associating the first location of the transport device with the first image data; receiving, from at least one of the one or more cameras, second image data reproducible as a second image of a second portion of the railroad track; analyzing the second image data to identify the presence or absence of one or more features of interest on the second portion of the railroad track; determining a second location of the transport device; and associating the second location of the transport device with the second image data.

The above summary is not intended to represent each embodiment or every aspect of the present invention. Additional features and benefits of the present invention are apparent from the detailed description and figures set forth below.

### BRIEF DESCRIPTION OF THE DRAWINGS

FIG. 1A is a schematic block diagram of a railroad inspection system according to some implementations of the present disclosure;

FIG. 1B is an illustrative schematic diagram of the railroad inspection system of FIG. 1A according to some implementations of the present disclosure;

FIG. 2 is a flowchart for a method of inspecting a railroad track according to some implementations of the present disclosure;

FIG. 3A is a perspective side view of a camera and light source of a railroad inspection system according to some implementations of the present disclosure;

FIG. 3B is a perspective end-on view of the railroad inspection system of FIG. 3A according to some implementations of the present disclosure; and

FIG. 4 is a perspective view of cameras and light sources of a railroad inspection system according to some implementations of the present disclosure.

While the disclosure is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

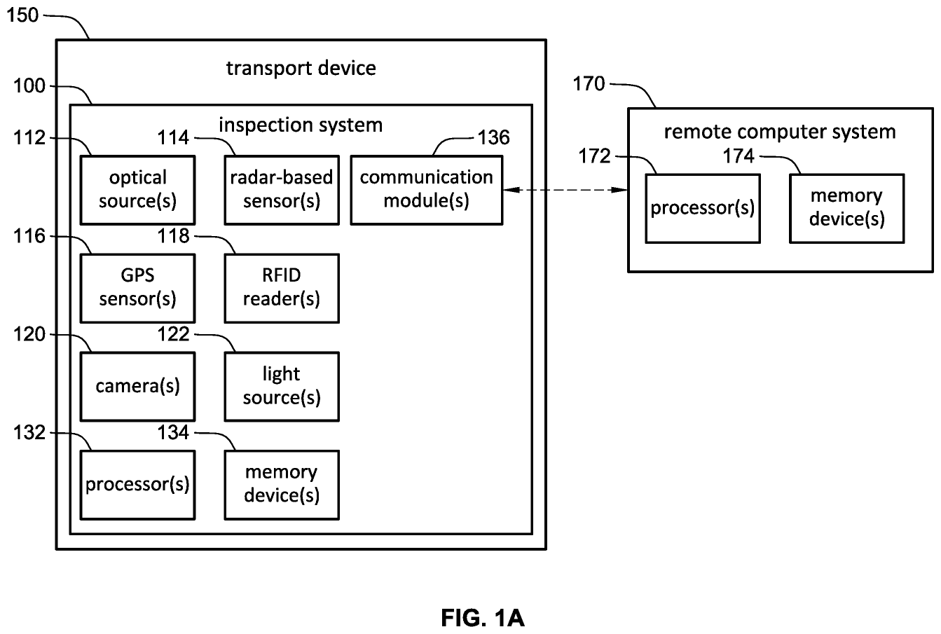

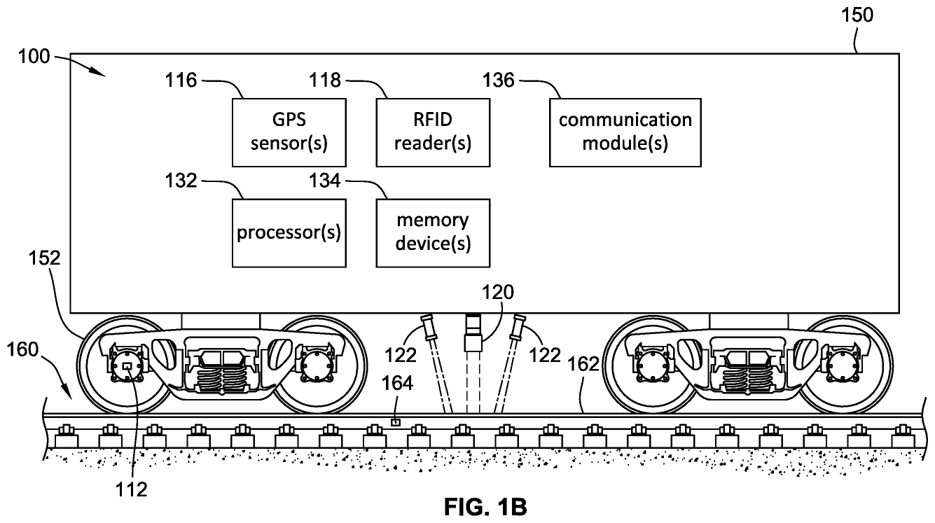

Referring generally to FIGS. 1A and 1B, a railroad inspection system 100 includes one or more optical sensors 112, one or more radar-based sensors 114, one or more global positioning system (“GPS”) sensors 116, one or more radio frequency identification (“RFID”) readers 118, one or more cameras 120, one or more light sources 122, one or more processors 130, one or more memory devices 132, and one or more communication modules 134. The railroad inspection system 100 is coupled to a transport device 150 and is generally used to identify one or more features of interest (e.g., defects, cracks, misalignment, missing elements, etc.) a portion of a railroad track, and associate those features of interest with a location of the transport device. The railroad track includes a plurality of components that can be inspected, including, for example, one or more rails, joint bars, ties, fasteners, ballast, or any combination thereof. In some implementations, the railroad inspection system 100 analyzes image data from the camera(s) 120 to identify features of interest and transmits this information to a remote computer system. In other implementations, the railroad inspection system 100 transmits image data from the camera(s) 120 to a remote computer system, which analyzes the image data to identify features of interest.

The railroad inspection system 100 is coupled to a transport device 150 that is moveable along one or more rails of a railroad track. As shown in FIG. 1B, the transport device 150 includes a plurality of wheels that engage a railroad track 160 such that the transport device 150 is moveable along one or more rails of the railroad track 160. The transport device 150 can be, for example, a locomotive, a railcar, a passenger car, a freight car, a railroad vehicle, a road vehicle (e.g., a vehicle configured to operate on both railroad tracks and a conventional surface road), etc. More generally, the transport device 150 can be any suitable device that is configured to move along the railroad track 160. The railroad track 160 can any type of track, such as, for example, subway tracks, elevated train tracks, high speed rail tracks, monorail tracks, tram tracks, etc.

The optical sensor(s) 112 of the railroad inspection system 100 are configured to detect movement of the transport device 150 along the railroad track 160. More specifically, in some implementations, the optical sensor(s) 112 includes an optical encoder that detects rotational position changes and converts the angular position or motion to analog or digital signal outputs. As shown in FIG. 1B, the optical sensor 112, which includes an optical encoder, is coupled to an end of an axle 152 of the transport device 150. While one optical sensor 112 is shown as being coupled to one axle 152 of the transport device 150 in FIG. 1B, more generally, any suitable number of optical sensors can be coupled to any suitable number of axles of the transport device 150 (e.g., one optical sensor is coupled to each axle of the transport device 150, etc.)

In other implementations, the optical sensor(s) 112 are generally aimed at the ground (e.g., aimed generally in the direction of the railroad track) and can determine motion, distance traveled, and/or speed of the transport device 150. As described in further detail herein, the optical sensor(s) 112 are communicatively coupled to the processor(s) 132, which can determine, for example, position, speed, and/or distance traveled by the transport device 150 based on the signal output of the optical sensor(s) 112. The processor(s) 132 automatically actuate the camera(s) 120 responsive to receiving signals or data from the optical sensor(s) 112 indicating that the transport device 150 is moving along the railroad track 160.

In addition to, or in the alternative of, the optical sensor(s) 112, the radar-based sensor(s) 114, the GPS sensor(s) 116, or both, can be used to detect movement of the transport device 150 along the railroad track 160. The radar-based sensor(s) 114 are configured to detect movement, speed, and/or distance traveled by the transport device 150 by emitting radar signals generally in the direction of the ground underneath the transport device 150 while the transport device 150 is moving. These radar signals are reflected by the ground back to the radar-based sensor(s) 114, which are configured to analyze the reflected signals to detect movement, speed, and/or distance traveled by the transport device 150.

The GPS sensor(s) 116 can be used to determine a location (e.g., latitude and longitude, or other coordinates) of the transport device 150 in real-time. For example, the GPS sensor(s) 116 can determine a first location of the transport device 150 at a first time and a second location of the transport device 150 at a second time. If the first location is different than the second location, this indicates that the transport device 150 has moved, and this information can be used to actuate the camera(s) 120. The GPS sensor(s) 116 can also be used to determine a distance traveled by the transport device 150 along the railroad track within a given time interval.

The RFID reader(s) 118 of the railroad inspection system 100 include an antenna configured to receive location information from RFID tags positioned on or along the railroad track 160. Referring to FIG. 1B, an RFID tag 164 is coupled to a rail 162 of the railroad track 160. The RFID tag 164 stores location information such as, for example, GPS coordinates or a distance relative to one or more landmarks along the railroad track 160 (e.g., mileposts, chain markers, signals, stations, or other railroad assets). This location information from the RFID tag 164 is automatically received by the RFID reader(s) 118 of the railroad inspection system 100 when the RFID tag 164 is within sufficient proximity to the RFID reader(s) 118 (e.g., as the transport device 150 passes over the RFID tag 164 coupled to the rail 162). The RFID tag 164 can also store and/or be associated with (e.g., via a look up table, etc.) other types of information, such as, for example, a track number, a switch number, a crossing number, a station number, a signal number, etc.

While the RFID reader(s) 118 are shown as being coupled to underside of the transport device 150, the RFID reader(s) 118 can be more generally be coupled to any suitable location on the transport device 150 (e.g., on either side of the transport device 150, on either end of the transport device 150, etc.) such that it is within sufficient proximity to receive location information from RFID tags positioned on or along the railroad track 160.

During operation of the railroad transport system 100, the transport device 150 may travel through a tunnel or other structure such that the GPS sensor(s) 116 cannot obtain an adequate signal (e.g., satellite or cellular signal) to reliably and accurately determine the location of the transport device 150 such that the features of interest can be associated with a location. Advantageously, the RFID reader(s) 118 can be used to determine a location of the transport device 150 by obtaining location data from RFID tags (e.g., RFID tag 164 of FIG. 1B) that are periodically placed along the railroad track 160. Once the railroad inspection system 100 determines a first location based on location data from an RFID tag on the railroad track 160, the system 100 can continuously determine the location of the transport device 150 by determining a distance traveled from the first location (e.g., using the optical sensor(s) 112 and/or the radar-based sensor(s) 114) until location data from another RFID tag on the railroad track 160, or GPS information, is received.

The camera(s) 120 and the light source(s) 122 of the railroad inspection system 100 are generally used to produce image data reproducible as an image of a portion of one or more rails of the railroad, from which the system 100 can identify the presence or absence of one or more features of interest on the railroad track. The defects that can be identified include cracks, pitting defects (which may be depressions defined in the rail head surface), grinding marks (e.g., marks left by rail grinding machines used to perform maintenance on the rails), flaking or spalling (e.g., pieces of surface material detaching from the rail head surface), missing track elements, cracked or broken track elements, fouled ballast, or any combination thereof.

Referring to FIG. 1B, the camera(s) 120 and the light source(s) 122 of the railroad inspection system 100 are coupled to the underside of the transport device 150 and are aimed at a surface of a rail 162 of a railroad track 160. The camera(s) 120 are configured to generate image data that is reproducible as one or more images of the surface of the rail 162 of the railroad track 160. The camera(s) 120 can include line scan cameras, area-scan cameras, video cameras, still cameras, or the like, or any combination thereof.

The light source(s) 122 are generally used to illuminate the rail 162 underneath the transport device 150 to aid the camera(s) 120 in generating image data reproducible as one or more images of the surface of the rail 162 from which the presence or absence of one or more features of interest on the rail can be identified by the processor(s) 132, as described in further detail herein.

The optical sensor(s) 112, radar-based sensor(s) 114, GPS sensor(s) 116, RFID reader(s) 118, camera(s) 120, light source(s) 122, or any combination thereof are coupled to the processor(s) 132, the memory device(s) 134, or both. As shown in FIG. 1B, the processor(s) 132 and the memory device(s) 134 are coupled to (e.g., located on) the transport device 150.

The processor(s) 132 are configured to automatically actuate the camera(s) 120 and the light source(s) 122 responsive to determining that the transport device 150 is moving via data from the optical sensor(s) 112, the radar-based sensor(s) 114, and/or GPS sensor(s). Likewise, the processor(s) 132 are configured to automatically turn off the camera(s) 120 and the light source(s) 122 responsive to determining that the transport device 150 is no longer moving via data from the optical sensor(s) 112, the radar-based sensor(s) 114, and/or GPS sensor(s) 116. The processor(s) 132 of the inspection system 100 are coupled to the transport device 150 (e.g., the processor(s) 132 of the inspection system 100 are physically on the transport device 150 and/or directly attached to the transport device 150).

Advantageously, automatically actuating the camera(s) 120 in response to movement of the transport device 150 aids in preventing large, unnecessary amounts of image data from being produced, or consuming power, while the transport device 150 is stationary. Further, automatically actuating the camera(s) 120 responsive to movement, and automatically turning the camera(s) 120 off responsive to the end of movement, obviates the need for an operator to manually actuate the camera(s) 120, meaning that the railroad inspection system 100 does not require an operator to be physically present on the transport device 150 during operation. As such, in some implementations, the railroad inspection system 100 can be coupled to any suitable transport device (e.g., a passenger car, a freight car, a locomotive, etc.), rather than a separate, specialized inspection transport device.

In some implementations, the processor(s) 132 are also configured to analyze image data received from the camera(s) 120 to identify the presence or absence of one or more features of interest on a portion of the railroad track, as described in further detail below.

The memory device(s) 134 are configured to receive the image data from the camera(s) 120. As described in further detail herein, in some implementations, the memory device(s) 134 store a reference map including locations of a plurality of landmarks (e.g., mileposts, chain markers, signals, stations, other railroad assets, etc.) such that the image data can be associated with one or more of the plurality of landmarks (e.g., a distance from a landmark is associated with the feature(s) of interest).

The communication module(s) 136 of the railroad inspection system 100 are configured to wirelessly communicate with a remote computer system 170 that is not located on (e.g., not coupled to) the transport device 150. The remote computer system 170 can be a computer, a laptop, a tablet, a smartphone, a server, or the like, and includes one or more processors 172 and one or more memory devices 174. Because the remote computer system 170 is not located on the transport device 150, a user can receive and analyze data from the railroad inspection system 100 without having to be physically located on the transport device 100. As a result, the railroad inspection system 100 can be coupled to a revenue generating railroad car (e.g., a locomotive, a passenger car, a freight car, etc.), rather than a separate, specialized railroad car or vehicle that requires additional personnel to be physically present on the railroad throughout the inspection process.

In some implementations, the remote computer system 170 receives raw image data from the wireless communication module 136 of the railroad inspection system 100, and the processor(s) 172 of the remote computer system 170 analyze the received image data to identify the presence or absence of features of interest. In other implementations, as described in further detail herein, the processor(s) 132 of the railroad inspection system 100 are configured to analyze the image data from the camera(s) 120 to identify the presence or absence of one or more features of interest on a portion of the railroad track and associate the features of interest with a location of the transport device 150. In such implementations, responsive to identifying the presence of one of more features of interest, the communication module(s) 136 of the railroad inspection system 100 are configured to wirelessly communicate identified features of interest and associated locations to the remote computer system 170.

While the railroad inspection system 100 has been shown and described herein as including the optical sensor(s) 112, radar-based sensor(s) 114, GPS sensor(s) 116, RFID reader(s) 118, camera(s) 120, light source(s) 122, processor(s) 130, memory device(s) 132, and communication module(s) 134, in some implementations, the railroad inspection system 100 can include more, or less, components. For example, in some implementations, the railroad inspection system 100 includes the optical sensor(s) 112, but not the radar-based sensor(s) 114.

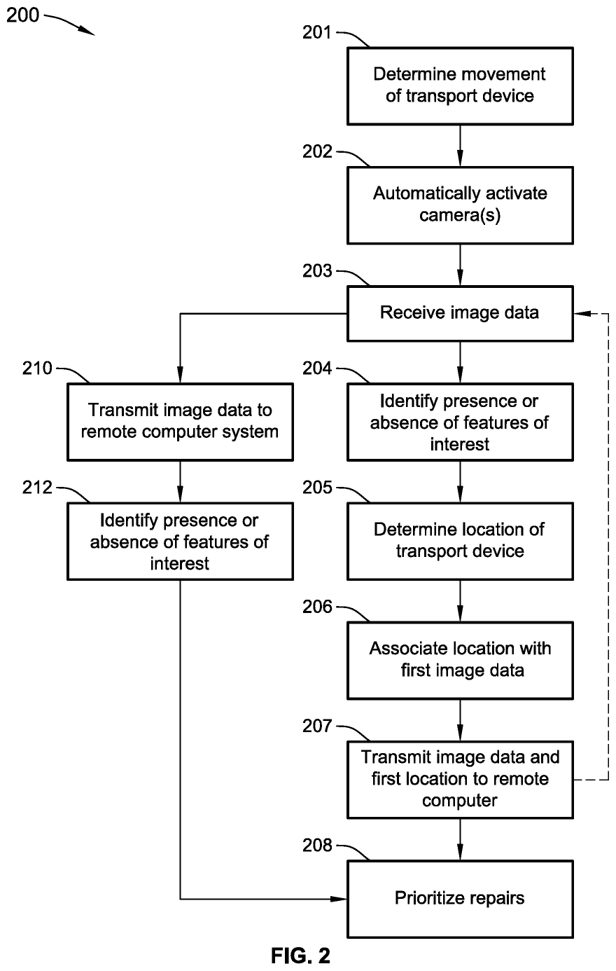

Referring to FIG. 2, a method 200 for inspecting a railroad track is illustrated. For example, the method 200 can be used to inspect a railroad track using the railroad inspection system 100 (FIGS. 1A and 1B) described herein.

Step 201 of the method 200 includes determining, using one or more sensors, movement of a transport device along the railroad track. As described herein, in some implementations, an optical sensor (e.g., the optical sensor(s) 112) detect movement of the transport device (e.g., transport device 150 in FIG. 1B) by detecting rotational position changes and converts the angular position or motion to analog or digital signal outputs. In other implementations, a radar-based sensor (e.g., radar-based sensor(s) 114) is used to detect movement of the transport device. In still other implementations, a GPS sensor can be used to detect movement of the transport device if the GPS coordinates of the transport device at a second time is different than the GPS coordinates at a first time, indicating that the transport device is moving.

Step 202 of the method 200 includes automatically actuating one or more cameras (e.g., camera(s) 120) and one or more lights (e.g., light source(s) 122) of the inspection system responsive to determining that the transport device is moving. More specifically, in some implementations, one or more processors of the inspection system are communicatively coupled to the optical sensor and determine that the transport device is moving based on the received signals. The processor(s) are also communicatively coupled to the camera(s) and light(s) and automatically actuate the camera(s) and light(s) responsive to receiving signals indicative of movement. If the processor(s) determine that the transport device is no longer moving based on signals from the optical sensor, the processor(s) turn off the camera(s) and light(s) to aid in preventing the capture of large amounts of unnecessary data.

Step 203 of the method 200 includes receiving image data reproducible as an image of a portion of a surface of a railroad track from the camera. The image data from the camera is stored in a memory device of the inspection system. Step 204 includes analyzing the received image data to identify the presence or absence of one or more features of interest, as described in further detail below.

Step 205 of the method 200 includes determining a location of the transport device using the optical sensor (e.g., optical sensor(s) 112), a radar-based sensor (e.g., radar-based sensor(s) 114), a GPS sensor (e.g., GPS sensor(s) 116), an RFID reader (e.g., RFID reader(s) 118), or any combination thereof. For example, in some implementations, step 205 includes obtaining the location (e.g., GPS coordinates such as latitude and longitude) of the transport device using a GPS sensor.

In other implementations, step 205 includes using an RFID reader that receives location information from an RFID tag positioned adjacent to (e.g., coupled to) the railroad track (e.g., RFID tag 164 of FIG. 1B). The location information from the RFID tag can include GPS coordinates or a distance relative to one or more landmarks along the railroad track 160 (e.g., mileposts, chain markers, signals, stations, or other railroad assets). The location information can also include, for example, a track number, a switch number, a crossing number, a station number, a signal number, etc. to further specify the location of the transport device. Advantageously, the RFID tag can provide location information in areas where a GPS signal cannot be reliably acquired (e.g., when the transport device is traveling through a tunnel or dead zone). In some implementations, step 205 includes using the location information from the RFID tag can be in conjunction with coordinates obtained from a GPS sensor to determine a location of the transport device.

In still other implementations, step 205 includes using the optical sensor and/or radar-based sensor to determine a distance traveled relative to a reference point to determine the location of the transport device. For example, an initial reference point can be obtained using a GPS sensor and/or the RFID reader. The optical sensor and/or radar-based sensor can be used determine a distance traveled relative to the initial reference point, and thus the location of the transport device can be determined. In some implementations, a reference map stored in the memory device of the inspection system can be used in conjunction with the initial reference point and calculated distance to determine the location of the transport device.

In some implementations, step 205 also includes using a reference map stored in a memory device of the inspection system to further associate the image data with other location-related information. In other words, the determined location of the transport device can be compared to the reference map such that information/data other than an absolute or relative position can be associated with the image data. For example, the image data can be associated with a track number, a switch number, a crossing number, a station number, a signal number, etc. to further specify the location of the transport device. As described herein, this additional information can aid in prioritizing repairs to identified defects along the railroad track.

Generally, determining the location in step 205 can occur before, substantially simultaneously with, or after the analyzing step 204. In some implementations, if no features of interest are identified in a given image data set during step 204, then step 205 is not performed for that image data set. In other words, in such implementations, step 205 occurs responsive to identifying the presence of a feature of interest in the image data during step 204. Advantageously, only associating the location with image data containing a feature of interest may reduce the processing requirements of the system. In other implementations, step 205 is performed regardless of whether the presence of a feature of interest is identified during step 204. In other words, in such implementations, the image data that does not contain a feature of interest is still associated with the location of the transport device.

In such implementations where step 205 is performed before, or substantially simultaneously with, the analyzing step 204, the analyzing step 204 can include using machine vision algorithms that are trained to recognize features of interest in the image data. Alternatively, the analyzing step 204 can include using an image processing algorithm that matches patterns in the image data with a well-developed set of training or reference images. In other words, the image data is compared to a database of reference or training images (e.g., stored in the memory device of the inspection system or the memory device of the remote computer) to identify the presence or absence of features of interest.

In some implementations, and preferably, analyzing the image data to identify the presence or absence of features of interest during step 205 does not include comparing the image data to a library of images containing features of interest. In other implementations, the image data is compared to a library of features of interest during step 205 in order to identify features of interest in the image data.

Step 206 includes associating the determined location of the transport device with the image data. Step 206 can occur before, or after, step 204. In other words, in some implementations, the image data can be associated with the determined location (step 206) before the analyzing to identify the presence or absence of one or more features of interest (step 204). Alternatively, the image data can be associated with the determined location (step 206) after the analyzing to identify the presence or absence of one of more features of interest (step 204). For example, in some implementations, step 206 occurs responsive to identifying the presence of one or more features of interest in a portion of the image data.

Step 207 of the method 200 includes transmitting at least a portion of the image data and associated location to a remote computer system (e.g., the remote computer system 170 of FIG. 1A). In some implementations, step 207 includes transmitting at least a portion of the image data and associated location regardless of whether a feature of interest has been identifying during step 204. In such implementations, transmitting the image data for each location even if there is no feature of interest can be advantageous because the remote computer system can later compare newly acquired image data for each location with the previously recorded data associated with each location to identify features of interest.

In other implementations, step 207 includes transmitting at least a portion of the image data and associated location responsive to identifying a feature of interest in the image data. In other words, image data is only transmitted if a feature of interest is present. Further, in such implementations, step 207 includes transmitting an image snippet of an identified feature of interest of an identified feature of interest. Rather than sending all of the image data, the image snippet includes all or substantially all of the feature of interest and includes areas of the image data where there is no identified feature of interest (e.g., the image snippet is limited to an identified crack on an edge of the rail, rather than an image of the entire surface of the rail). Advantageously, in such implementations, the volume of data that is transmitted to the remote computer system is reduced compared to sending image data for every location despite the fact that many locations do not have a feature of interest.

Generally, once the image data and associated locations are transmitted to the remote computer system (step 207), this information is available to users of the remote computer system to review. In some implementations, the remote computer system can be configured to transmit a notification to one or more recipients responsive to receiving image data in which a feature of interest has been identified. For example, in such implementations, the remote computer system may automatically transmit a notification (e.g., e-mail, text message, etc.) to a third party indicating what feature(s) of interest were identified at a location along the railroad track. Thus, recipients can be notified in near real-time of defects that are identified by the inspection system as the transport device is traveling along the railroad track, enabling those recipients to make decisions about the need for urgent repairs, short term remedial actions, or long-term railroad track maintenance planning.

As the transport device continues to move along the railroad track (e.g., from a first location to a second location, from the second location to a third location, and so forth), steps 203 through 207 can be repeated one or more times such that the image data and associated locations that are transmitted to the remote computer system include data reproducible as images of the entire length of the railroad track. In this manner, all (or substantially all of) the railroad track can be inspected.

Optional step 208 of the method 200 includes prioritizing repairs of the railroad tracks based on the transmitted image data. As described herein, there many different types of features of interest (e.g., defects) that can be identifying in the image data, and each feature of interest may have a different severity. For example, it may be determined that a first crack identified at a first location is larger than a second crack identified at a second location. In this case, repair of the first crack can be prioritized over repair of the second crack. Likewise, priority of the first or second crack may be determined based on the associated location. For example, if it is determined that the first crack is in close proximity to repair assets, the repair of the first crack can be prioritized over the second crack to quickly eliminate one potential safety hazard.

Similarly, prioritization of repairs in optional step 208 can be based on other factors, such as, for example, the location associated with the feature of interest. If a first defect is identified at a first location and a second crack is identified at a second location, further information about the first location and the second location can be used to prioritize repair of the first or second crack. For example, as described herein, a track number can be associated with the image data and associated location. In turn, the track number can be associated with railroad traffic data, such as, for example, rail traffic volume (e.g., a heavily used stretch of track or a rarely used stretch of track), rail traffic type (e.g., passenger, freight, hazardous or dangerous freight, etc.), rail traffic speed (e.g., a high-speed straightaway, a low speed curve, etc.) Prioritization of the repairs of the first crack and second crack can be determined based on this railroad traffic data. For example, if it is determined that the first crack is located in a heavily used, high speed stretch of track, and the second crack is located in a rarely used, low speed stretch of track, repair of the first crack is prioritized over the second crack.

In some implementations, rather than transmitting the image data and associated location to the remote computer system (step 207) subsequent to analyzing the image data (step 205) to identify the presence or absence of features of interest, the method 200 includes step 210. Step 210 includes transmitting the image data to the remote computer system prior to analyzing the image data to identify the presence or absence of features of interest. As described herein, the remote computer system is not located on (e.g., coupled to) the transport device. In such implementations, the method 200 also includes step 212. Step 212 includes analyzing the received image data to identify the presence or absence of features of interest

Associating the image data with the determined location of the transport device (step 206) can occur before, or after, the image data is transmitted to the remote computer system (step 210). In other words, the image data can be associated with the location of the transport device by the processors of the inspection system coupled to the transport device, and this image data and associated location is then transmitted to the remote computer system for analysis (steps 210 and 212). Alternatively, the image data and raw data for determining the location of the transport device can be transmitted to the remote computer system, and the processors of the remote computer system can be used to determine the location of the transport device and associate that location with the image data.

Advantageously, as compared to analyzing the image data using the processor(s) of the inspection system (step 204), the use of steps 210 and 212 aid in reducing the processing and power requirements of the inspection system coupled to the transport device.

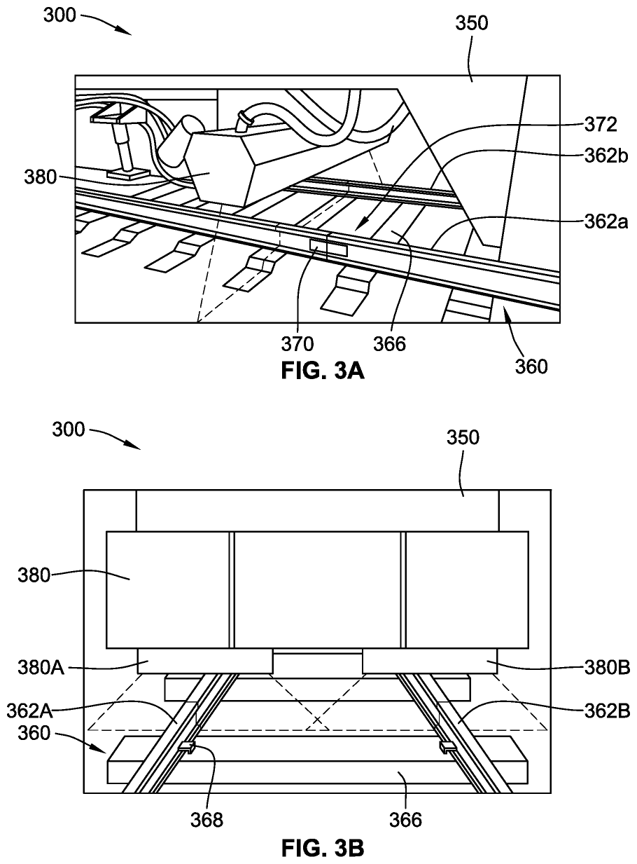

Referring to FIGS. 3A and 3B, a railroad inspection system 300 that is similar the railroad inspection system 100 (FIGS. 1A and 1B) described herein is shown. The railroad inspection system 300 includes cameras and light sources that are mounted to the underside of transport device 350 so that the cameras and light sources are disposed above the rails. More specifically, the cameras and the light sources are positioned within a housing 380 (FIG. 3A) or housing portions 380A and 380B (FIG. 3B) to protect them during use. The cameras and the light sources point downward toward the railroad track 360, which includes rail 362A, rail 362B, cross-ties 366, fasteners 368, joint-bar 370, and ballast 372 (e.g., crushed stone). The light sources illuminate the railroad track 360 as the cameras generate image data that can be reproduced as images of at least a portion of the surfaces of the rails 362A, 362B, cross-ties 366, fasteners 368, joint-bars 370, ballast 372, other railroad track components, or any combination thereof.

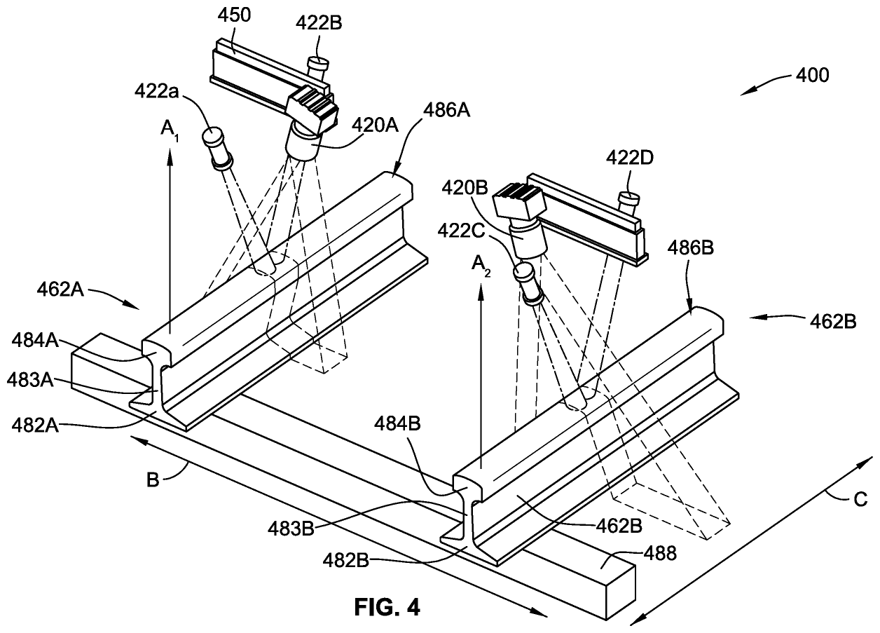

Referring to FIG. 4, a railroad inspection system 400 that is similar to the railroad inspection system 100 (FIGS. 1A and 1B) and the railroad inspection system 300 (FIG. 3) is shown. The railroad inspection system 400 includes one or more cameras 420, including a first camera 420A and a second camera 420B coupled to transport device 450. The first camera 420A is mounted above a first rail 462A of the rail track 460. The second camera 420B is mounted above a second rail 462B of the rail track 460. Each rail 462A, 462B comprises a rail base 482A and 482B, a rail web 483A and 483B, and a rail head 484A and 484B. The rail base 482A, 482B of each rail 462A, 462B rests on one or more crossties 488, which generally span at least the distance between the rails 462A, 462B. When the transport device 450 or other vehicle travels along the rails 462A, 462B, the wheel of the transport device or other vehicle rest on surfaces 486A and 486B of the rail heads 484A, 484B. The rail head surfaces 486A, 486B of each rail 462A, 462B are both generally curved along the width of the rail head surfaces 486A, 486B to form a slight arch with respect to the ground. However, in some implementations, the rail head surfaces 486A, 486B are flat.

Camera 420A is generally aimed only at rail 462A, while camera 420B is generally aimed only at rail 462B. However, some implementations one or more of the cameras could be aimed at multiple rails. Each camera 420A, 420B is spaced apart from its respective rail 462A, 462B along a respective vertical axis A₁ and A₂. These axes extend upwards from the rail head surfaces 486A, 486B of rails 462A, 462B respectively. Axes A₁ and A₂ are also each generally perpendicular to the rail head surfaces 486A, 486B. However, because the rail head surfaces 486A, 486B, axes A₁ and A₂ may not be perpendicular to the rail head surfaces 486A, 486B at every point along the rail head surfaces 486A, 486B. However, axes A₁ and A₂ are generally perpendicular at least to the center of the rail head surfaces 486A, 486B. Furthermore, while axes A₁ and A₂ are referred to as vertical axes for ease of understanding, depending on the layout of the track and its relation to the ground, axes A₁ and A₂ may not always be completely vertical.

Axes A₁ and A₂ are also each generally perpendicular to both a transverse axis B (which extends between and connects the rails 462A, 462B) and a longitudinal axis C (which extends along the length of the rails 462A, 462B). Cameras 420A and 420B are generally mounted inwardly relative to rails 462A and 462B, respectively. In this manner, camera 420A is further spaced apart from rail 462A along the second axis B towards rail 462B. Similarly, camera 420B is further spaced apart from rail 462B along the second axis B towards rail 462A. Cameras 420A and 420B are thus positioned at angles θ₁ and θ₂ relative to axes A₁ and A₂, respectively. In some implementations, angles θ₁ and θ₂ can be between about 0.1° and about 20°, between about 5.0° and about 12.0°, or about 5.0°. Both of the cameras 420A and 420B can be mounted at the same angle relative to their respective vertical axes A₁ and A₂, or they could each be mounted at separate angles relative to axes A₁ and A₂. In some implementations, one or both of cameras 420A, 420B could be mounted at an angle of 0° relative to their respective vertical axes A₁ and A₂, e.g., the cameras can be mounted directly over the rail head surfaces 486A, 486B.

Regardless of the angle θ₁, θ₂ at which cameras 420A, 420B are disposed at relative to the vertical axis, cameras 420A, 420B are generally aimed at the rail head surfaces 486A, 486B, respectively. Thus, camera 420A and 420B are not always aimed directly downward with respect to where they are coupled to transport device at, e.g., parallel to axes A₁ and A₂ respectively. Rather, cameras 420A and 420B are generally aimed outward towards rails 462A, 462B respectively. Camera 420A is thus aimed at an angle back towards rail head surface 486A, while camera 420B is aimed at angle back towards rail head surface 486B. These angles are generally equal to angles θ₁ and θ₂, respectively. However, in some implementations, these angles are different from angles θ₁ and θ₂, respectively.

The camera 420A, 420B are generally positioned inwardly and aimed outwardly with respect to rails 462A and 462B to ensure that the images that are produced from the generated image data clearly show the areas of the rail head surfaces 486A, 486B closer the inner edges, 38B of rails 462A, 462B, e.g., the right edge of the left rail 462A, and the left edge of the right rail 462B. Most vehicles that travel along tracks, such as a train car traveling along a railroad track, have wheels with inner flanges that extend downward along the inner side of the rails 462A, 462B. As a result, there is generally more contact between the wheels and the inner areas of the rail head surfaces 486A, 486B that are closer to the inner edges of the rails 462A, 462B. These inner areas of the rail head surfaces 486A, 486B can be damaged more easily, and thus it is important to produce images that fully shows these inner areas.

More generally, cameras 420A and 420B can generate image data reproducible as one or more images of rail 462A, rail base 482A, rail web 483A, rail head 484A, rail head surface 486A, rail 462B, rail base 482B, rail web 483B, rail head 484B, rail head surface 486B, cross-tie 488, fasteners (e.g., fasteners that are the same as, or similar to, fasteners 368 of FIG. 3B), joint-bars (e.g., joint-bars that are the same as, or similar to, joint-bar 370 of FIG. 3B), ballast (e.g., crushed stone between crosstie 488 and adjacent cross-ties), other railroad track components, or any combination thereof.

FIG. 4 also illustrates the arrangement of the one or more light sources relative to the rail head surfaces 486A, 486B. Each light source is configured to aid in illuminating the railroad track. As shown, the one or more light sources can include first and second light sources 422A and 422B that illuminate the railroad track components adjacent to rail 462A, as well as third and fourth light sources 422C and 422D that illuminate the railroad track components adjacent to rail 462B. The light sources 422A, 422B and 422C, 422D are generally disposed at the same vertical position as their respective camera 420A, 420B. As such, first and second lights sources 422A and 422B are spaced apart from rail 462A along axis A₁, while third and fourth light sources 422C and 422D are spaced apart from rail 462B along axis A₂.

Unlike camera 420A, 420B however, light sources 422A-422D are generally not spaced apart from the rail along axis B, e.g., are not angled inwardly or outwardly with respect to rails 462A, 462B. However, light sources 422A-422D are spaced apart along axis C from the portion of the rail head surfaces 486A, 486B that light sources 422A-422D are illuminating. Light sources 422A-422D are thus aimed at an angle toward rail head surfaces 486A, 486B. As best shown in FIG. 4C, light sources 422A and 422B are spaced apart along the length of rail 462A from the portion of the rail head surface 486A that they are illuminating. In this manner, light source 15A is spaced apart in a first direction along axis C, while light source 422B is spaced apart in a second direction along axis C opposite the first direction. Light sources 422A and 422B are thus disposed angles relative to axis A₁. Light sources 422A, 422B are aimed towards rail head surface 486A at a corresponding angle. Similarly, light sources 422C and 422D are spaced apart in opposite directions along axis C from the portion of rail head surface 486B that they are illuminating. As such, light sources 422C and 422D are also disposed at angles relative to axis A₂, and aimed towards rail head surface 486B at corresponding angles. In some implementations, one or more of the light sources 422A-422D are disposed at an angle of about 13°. In other implementations, these angles are between about 10° and about 15°, between about 5° and about 20°, or between about 0° and about 30°.

Other implementations of the system can have any number or arrangement of lights and camera. For example, in some implementations the system could include a single camera with a field of view wide enough to generate image data that can be reproduced into an image of both rails. Other implementations could include multiple cameras per rail. Still other implementations could modify the angle at which the cameras are positioned relative to the rail. For example, some implementations could have the cameras mounted directly above the rails and aimed straight down, or mounted outwardly from the rails and aimed inwardly. Implementations including multiple cameras per rail could have each camera for a rail disposed between the rails, or could have one camera disposed at an inward angle, one camera disposed directly above the rails, one camera dispose at an outward angle, etc. In other implementations, all of the cameras can be mounted at aimed at its own respective angle, which may be the same or different as the angle in one or more of the other cameras (e.g., two cameras, three cameras, four cameras, six cameras, etc.) of the system.

In some implementations, the system may include only a single light source per rail. Other implementations could include a single light source that illuminates both rails. The light sources can have a focused beam of light that has a width approximately equal to the width of the rail head surfaces. In other implementations, the width of the beam of light produced by the light sources is wider than the width of the rail head surfaces. Similar to the cameras, each light source can be mounted and aimed at an angle that can be the same or different from the angle of each of the other light sources.

While the present disclosure has been described with reference to one or more particular embodiments or implementations, those skilled in the art will recognize that many changes may be made thereto without departing from the spirit and scope of the present disclosure. Each of these embodiments or implementations and obvious variations thereof is contemplated as falling within the spirit and scope of the present disclosure. It is also contemplated that additional embodiments implementations according to aspects of the present disclosure may combine any number of features from any of the embodiments described herein.

1. A method for inspecting a railroad track, the method comprising:
detecting, using one or more sensors of an inspection system coupled to a transport device, an initial movement of the transport device along the railroad track;
responsive to detecting the initial movement of the transport device, automatically actuating one or more cameras of the inspection system;
receiving, from at least one of the one or more cameras, first image data reproducible as a first image of a first portion of the railroad track;
analyzing the first image data to identify the presence or absence of one or more features of interest on the first portion of the railroad track;
determining a first location of the transport device; and
associating the first location of the transport device with the first image data.

2. The method of claim 1, further comprising transmitting at least a portion of the first image data and the associated first location to a remote computer system responsive to identifying the presence of one or more features of interest on the first portion of the railroad track during the analyzing, wherein the analyzing includes using one or more processors of the inspection system to identify the presence or absence of the one or more features of interest.

3. The method of claim 2, wherein the transmitting occurs responsive to identifying the presence of one or more features of interest on the first portion of the railroad track during the analyzing.

4. (canceled)

5. The method of claim 1, further comprising transmitting at least a portion of the first image data and the associated first location to a remote computer system prior to the analyzing, wherein the analyzing includes using one or more processors of the remote computer system to identify the presence or absence of the one or more features of interest on the first portion of the railroad track.

6. The method of claim 2, wherein the transmitted at least a portion of the first image data and the associated first location includes an image snippet of an identified feature of interest on the first portion of the railroad track.

7. The method of claim 1, further comprising:
comparing the determined first location of the transport device with reference data to determine a railroad track identifier, a distance from one or more landmarks, or both, and
associating the first image data with the track identifier, the distance from one or more landmarks, or both.

8-9. (canceled)

10. The method of claim 1, wherein the determining the first location of the transport device includes determining a distance traveled by the transport device along the railroad track relative to an initial position and wherein the determining the distance traveled includes using (i) an optical encoder, (ii) a radar-based sensor, or (iii) both.

11. The method of claim 1, wherein the determining the first location of the transport device includes determining a distance traveled by the transport device along the railroad track relative to an initial position and wherein the determining the distance traveled includes receiving positional data associated with one or more RFID tags positioned along or adjacent to the railroad track.

12. (canceled)

13. The method of claim 1, wherein the one or more sensors include an optical encoder coupled to an axle of the transport device.

14-15. (canceled)

16. The method of claim 1, further comprising:
responsive to the detecting, automatically actuating one or more lights of the inspection system;
receiving, from at least one of the one or more cameras, second image data reproducible as a second image of a second portion of the railroad track;
analyzing the second image data to identify the presence or absence of one or more features of interest on the second portion of the railroad track;
determining a second location of the transport device;
associating the second location of the transport device with the second image data; and
responsive to identifying one or more features of interest in both the first image data and the second image data, automatically prioritizing, based on at least (i) the identified one or more features of interest on the first portion of the railroad track, (ii) the first location, (iii) the identified one or more features of interest on the second portion of the railroad track, (iv) the second location, or (v) any combination thereof, maintenance or repairs to the first portion of the railroad track or the second portion of the railroad track.

17. (canceled)

18. A system for inspecting a railroad track comprising:
one or more sensors coupled to a wheel of a transport device that is configured to travel along the railroad track, the one or more sensors being configured to generate motion data for use in detecting an initial movement of the transport device along the railroad track, the initial movement of the transport device occurring from a completely stationary orientation of the transport device;
one or more cameras coupled to the transport device and being configured to generate first image data reproducible as a first image of a first portion of the railroad track;
a wireless communication module;
one or more memory devices coupled to the transport device and being configured to receive and store the first image data therein; and
one or more processors coupled to the transport device and being configured to:
detect, using the motion data, the initial movement of the transport device;
automatically actuate the one or more cameras responsive to the detecting of the initial movement of the transport device along the railroad track; and
associate a first location of the transport device with the first image data.

19. The system of claim 18, wherein the one or more processors coupled to the transport device are configured to analyze the first image data to identify the presence of absence of one or more features of interest, and wherein the wireless communication module is configured to transmit a portion of the first image data and the first location to a remote computer system responsive to the one or more processors identifying the presence of one or more features of interest.

20-21. (canceled)

22. The system of claim 18, wherein the wireless communication module is configured to transmit the first image data and the first location to a remote computer system, the remote computer system including one or more processors configured to analyze the first image data to identify the presence or absence of one or more features of interest.

23. (canceled)

24. The system of claim 18, wherein the one more sensors include an optical encoder coupled to an axle of the transport device.

25. The system of claim 18, further comprising one or more RFID readers coupled to the transport device and being configured to receive position data using one or more RFID tags positioned adjacent to the railroad track.

26-27. (canceled)

28. A method for inspecting a railroad track comprising:
detecting, using one or more sensors of an inspection system coupled to a transport device, an initial movement of the transport device along the railroad track, the initial movement of the transport device occurring from a completely stationary orientation of the transport device;
responsive to detecting the initial movement of the transport device, automatically actuating one or more cameras of the inspection system;
receiving, from at least one of the one or more cameras, first image data reproducible as a first image of a first portion the railroad track;
analyzing the first image data to identify the presence or absence of one or more features of interest on the first portion of the railroad track;
determining a first location of the transport device;
associating the first location of the transport device with the first image data;
receiving, from at least one of the one or more cameras, second image data reproducible as a second image of a second portion of the railroad track;
analyzing the second image data to identify the presence or absence of one or more features of interest on the second portion of the railroad track;
determining a second location of the transport device;
associating the second location of the transport device with the second image data;
detecting, using the one or more sensors of the inspection system, that the transport device is no longer moving along the railroad track; and
responsive to the detecting that the transport device is no longer moving along the railroad track, automatically turning off the one or more cameras.

29. The method of claim 28, wherein the determining the first location of the transport device includes use of one or more GPS sensors and the determining the second location of the transport device does not include use of one or more GPS sensors.

30. The method of claim 28, wherein the determining the first location of the transport device includes use of one or more GPS sensors and the determining the second location of the transport device includes use of an optical encoder, a radar-based sensor, or both.

31. The method of claim 28, wherein the determining the first location of the transport device includes use of one or more GPS sensors and the determining the second location of the transport device includes use of one or more RFID tags positioned adjacent to the railroad track.

32. The method of claim 28, further comprising transmitting (i) at least a portion of the first image data and the associated first location to a remote computer system subsequent to the analyzing and (ii) at least a portion of the second image data and the associated second location to the remote computer system subsequent to the analyzing, wherein the analyzing includes using one or more processors of the inspection system to identify the presence or absence of the one or more features of interest.

33. The method of claim 32, wherein the transmitting occurs responsive to (i) identifying the presence of one or more features of interest on the first portion of the railroad track during the analyzing and (ii) identifying the presence of one or more features of interest on the second portion of the railroad track during the analyzing.

34. (canceled)

35. The method of claim 28, further comprising transmitting (i) at least a portion of the first image data and the associated first location to a remote computer system prior to the analyzing and (ii) at least a portion of the second image data and the associated second location to the remote computer system prior to the analyzing, wherein the analyzing includes using one or more processors of the remote computer system to identify the presence or absence of the one or more features of interest.

36. (canceled)

37. The method of claim 1, wherein responsive to being automatically actuated, each of the one or more cameras generates image data, the method further comprising responsive to detecting, using the one or more sensors of the inspection system, that the transport device is no longer moving along the railroad track, automatically turning off the one or more cameras of the inspection system.

38. (canceled)

39. The system of claim 1, wherein the analyzing the first image data includes using a trained algorithm to identify the presence or absence of the one or more features of interest.

40. The system of claim 1, wherein the analyzing the first image data does not include comparing the first image data to a library of images containing features of interest.
